(19) United States
(12) Patent Application Publication
(10) Pub. No.: US 2022/0331891 A1
(43) Pub. Date: Oct. 20, 2022

(54) METHOD FOR PRODUCING A ROTOR OF A SCREW COMPRESSOR OR A WORKPIECE WITH A HELICAL PROFILE

(71) Applicant: KAPP NILES GMBH & CO. KG, Coburg (DE)

(72) Inventor: Martin A. KAPP, Coburg (DE)

(21) Appl. No.: 17/641,267

(22) PCT Filed: Sep. 1, 2020
(86) PCT No.: PCT/EP2020/074362

§ 371 Date: Mar. 8, 2022

(30) Foreign Application Priority Data
Sep. 11, 2019 (DE) 10 2019 124 394.7

(51) Int. Cl. B23F 15/08; B23F 11/00; B23F 13/04; B24B 19/02

(52) U.S. Cl. CPC B23F 15/08; B23F 11/00; B23F 13/04; B24B 19/022

(57) ABSTRACT

A method for producing a rotor of a screw compressor or a workpiece with a helical profile, the rotor or the workpiece with a helical profile having a number of profiles in the form of groove-shaped recesses running in a spiral manner on the outer periphery thereof, the groove-shaped recesses being fine-machined using a grinding tool for the purpose of generating a precise profile. To be able to produce rotors and workpieces having variable pitch along the axial extent of the rotor or the workpiece as precisely as possible, the groove-shaped recesses are fine-machined with a grinding tool which only touches the surface of the groove-shaped recess at one point during the grinding process. The entire surface to be machined is machined by the grinding tool through line-by-line traversing of the surface to be machined.

The invention relates to a method for producing a rotor of a screw compressor or a workpiece with a helical profile, wherein the rotor or the workpiece with a helical profile has a number of profiles in the form of groove-shaped recesses running in a spiral manner on its outer circumference, wherein the groove-shaped recesses are fine-machined using a grinding tool for the purpose of generating a precise profile.

A generic method for manufacturing a screw compressor rotor is known from DE 10 2008 035 525 B3. For grinding the profiling on the outer circumference of the rotor, i.e. of the groove-shaped recesses, a screw-shaped tool is used here, both for pre-grinding and for finish-grinding the profiling. It has been known before to produce the profiling of such a rotor by using a profile grinding wheel whose grinding profile corresponds to the section through the profile along the feed of the grinding wheel.

Although such a rotor can in principle be precisely machined, this is often no longer possible if the pitch of the rotor profile changes over the axial extent of the rotor. A screw compressor with rotors of this type is disclosed, for example, in U.S. Pat. No. 3,424,373 A. Similarly, such rotors are also known from U.S. Pat. No. 9,770,772 B2, whereby profile grinding wheels are again used here for grinding the profiling, the grinding profile of which corresponds to the section through the profiling to be machined.

The invention is based on the object of further developing a generic method for fine machining the rotors of a screw compressor or a workpiece with a helical profile in such a way that, in particular, it is also possible to manufacture rotors or workpieces with a pitch that varies over the axial extent of the rotor or workpiece as precisely as possible.

The solution of this problem by the invention provides that the groove-shaped recesses are fine-machined with a grinding tool which only touches the surface of the groove-shaped recess at one point during the grinding process, wherein the entire surface to be machined is machined by the grinding tool through line-by-line traversing of the surface to be machined (topological grinding).

The line-by-line traversing is performed according to a preferred procedure by carrying out a number of grinding strokes in which the grinding tool is moved in radial direction relative to the rotor or to the workpiece having a helical profile.

The line-by-line traverse can also be performed according to another preferred procedure by performing a number of grinding strokes in which the grinding tool is moved in an axial direction relative to the rotor or workpiece with a helical profile.

Finally, another variant of the method provides that the line-by-line traverse is performed by executing a number of grinding strokes in which the grinding tool is moved in a combined radial direction and in an axial direction relative to the rotor or the workpiece with a helical profile. This allows the feed direction to be at any angle to the axis of rotation of the rotor or workpiece with a helical profile.

Preferably, a grinding tool in the form of a grinding wheel is used. In particular, the abrasive section of the grinding wheel has a gothic profile in radial section; alternatively, a grinding wheel with a full-radius profile in radial section has also proved particularly useful.

Furthermore, a steel base body tool is preferably used as the grinding wheel, which is coated with an abrasive material that is bonded to the steel base body by means of a galvanic coating. Alternatively, however, it is also possible to use dressable grinding wheels with a ceramic base body.

The proposed process is particularly suitable when the groove-shaped recesses of the rotor or of the workpiece with a helical profile have a variable pitch over the axial course of the rotor.

However, the proposed method is just as advantageous if the groove-shaped recesses of the rotor or of the workpiece with a helical profile have a variable profile over the axial course of the rotor or the workpiece with a helical profile. In this case, for example, the root circle approaches or moves away from the tip circle over the axial course of the rotor or the workpiece (conicity in the root cylinder).

When grinding of the groove-shaped recesses, the axis of rotation of the rotor or the workpiece with a helical profile and the radial infeed movement of the grinding wheel can be changed relative to each other in an interpolating manner.

Accordingly, it is also possible that during grinding of the groove-shaped recesses, the axis of rotation of the rotor or of the workpiece with a helical profile and the feed axis in the direction of the axis of rotation of the rotor are changed in an interpolating manner relative to each other.

A further embodiment for both of the aforementioned procedures provides that during grinding of the groove-shaped recesses, furthermore the swivel axis of the grinding tool and/or the feed axis of the grinding wheel in the axial direction of the grinding wheel are changed in an interpolating manner.

Thus, the present invention proposes a topological generation-grinding of the rotors of screw compressors or of workpieces with a helical profile, which is recommended not only, but preferably, for such rotors or workpieces whose profile has a variable pitch along the axial extension of the rotor.

By rotating the workpiece (especially of the rotor) and moving the grinding wheel radially (relative to the rotor), any point in the face section of the profiling to be machined can be approached. If, in addition, the feed axis is used in the rotor width direction (i.e. in the axis direction of the rotor or the workpiece with a helical profile), any point in space can be approached by the abrasive surface of the grinding wheel.

By adding the swivel axis of the grinding wheel and the tangential axis (in the direction of the axis of rotation of the grinding wheel) of the grinding wheel, collision-free machining can be ensured with appropriate computer-aided geometric consideration of the entire groove-shaped recess. For this purpose, up to five machine axes are moved simultaneously (interpolating), as mentioned above.

An example of an embodiment of the invention is shown in the drawings.

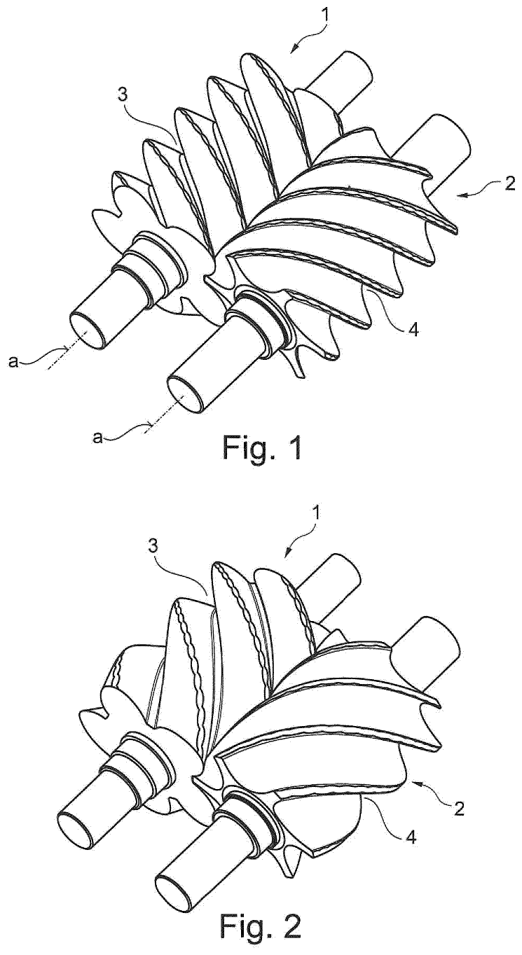

FIG. 1 shows a perspective view of two intermeshing rotors of a screw compressor, the pitch of the helical profiling of the rotors being constant over their axial extent,

FIG. 2 shows a perspective view of two intermeshing rotors of a screw compressor, the pitch of the helical profiling of the rotors being variable over their axial extent,

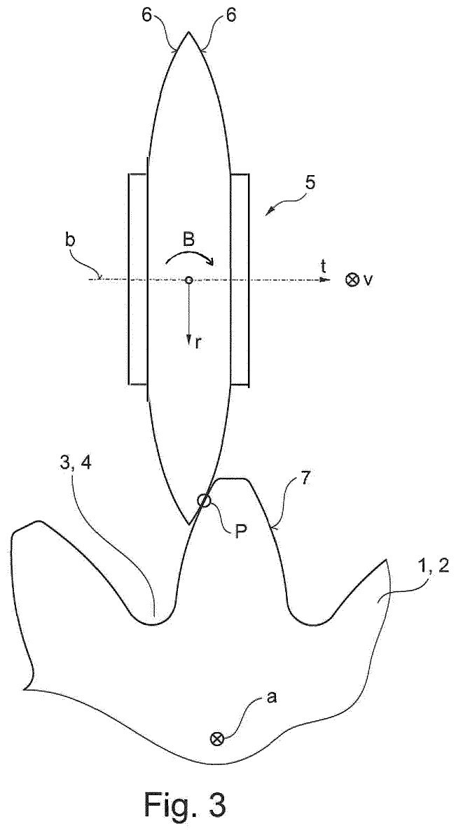

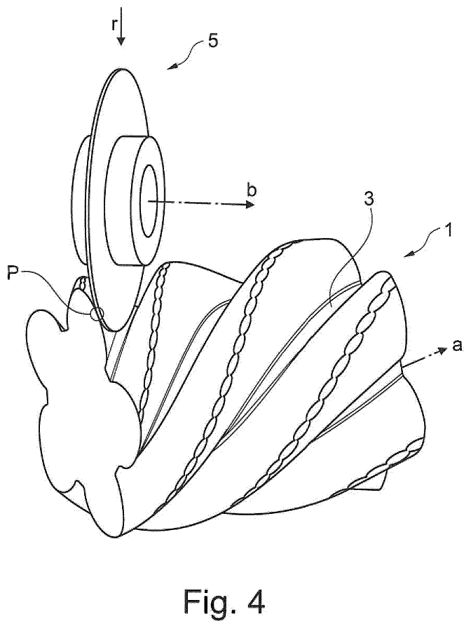

FIG. 3 shows schematically in a face section of the rotor the engagement conditions of a grinding wheel in the groove-shaped profile of the helical profiling of a rotor during the grinding process,

FIG. 4 shows a perspective view of the engagement conditions of the grinding wheel in the groove-shaped profile of the helical profiling of a male rotor during the grinding process,

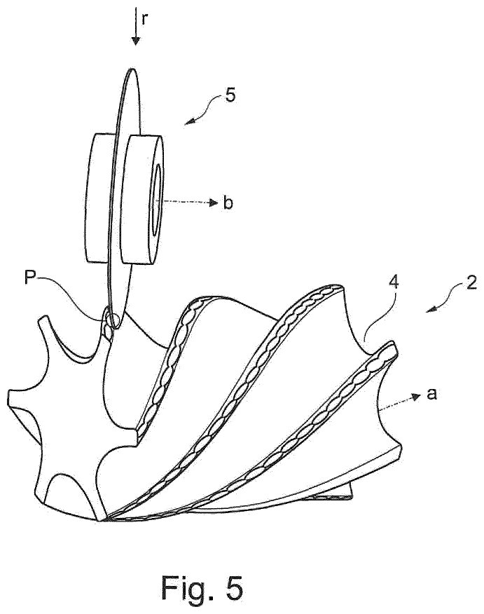

FIG. 5 shows a perspective view of the engagement conditions of the grinding wheel in the groove-shaped profile of the helical profiling of a female rotor during the grinding process,

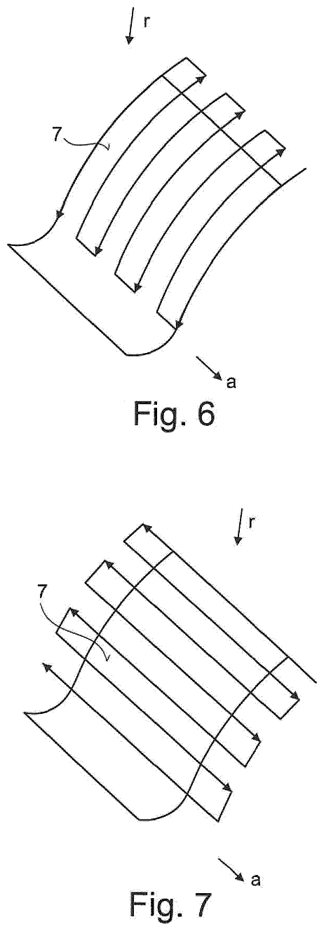

FIG. 6 shows schematically the course of movement of a grinding wheel over the surface of the groove-shaped recess according to a first embodiment of the invention, and

FIG. 7 shows schematically the course of the movement of the grinding wheel over the surface of the groove-shaped recess according to a second embodiment of the invention.

FIG. 1 shows a pair of intermeshing rotors of a screw compressor, a first rotor 1 (male) being in engagement with a second rotor 2 (female). Both rotors 1, 2 have helical and groove-shaped recesses 3 and 4, respectively, on their outer circumferences, which correspond to each other. Thus, when the pair of rotors rotates, a conveying effect is produced in a known manner. The respective axis of rotation of the rotors is designated by a.

Whereas in the rotors according to FIG. 1 the pitch of the groove-shaped recess is constant over the axial extension of the rotor, it is clear from FIG. 2 that this is not the case here. The pitch of the groove-shaped recesses is smaller at the right-hand end of the rotors than at the left-hand end; the pitch thus increases gradually from right to left.

The grinding process according to the invention is particularly recommended for such rotors with variable pitch.

This is illustrated in FIG. 3: Here it can be seen in a frontal section (the axis of rotation a of the rotor 1, 2 is perpendicular to the drawing plane) that a grinding tool 5 in the form of a grinding wheel is used to grind the surface 7 of the groove-shaped recesses 3, 4 in points or lines. The grinding wheel 5 has a gothic profile 6 which, in radial section, consists of two arcs which are joined at the tip.

The grinding wheel 5 can be moved relative to the rotor 1, 2 in radial feed direction r, while the rotor 1, 2 is simultaneously rotated about its axis of rotation a in an interpolating manner, i.e. the position of the abrasive surface of the grinding wheel 5 resulting from the nominal geometry is precisely controlled between the movement of the two axes a and r. Furthermore, it is possible that the grinding wheel 5 is moved simultaneously in the direction of the feed axis t, which points in the axial direction b of the grinding wheel 5. Finally, it is also possible for the grinding wheel 5 to be moved about the swivel axis B, which in FIG. 3 is perpendicular to the drawing plane and therefore perpendicular to the axis b.

During the grinding process, there is also a relative movement between the workpiece (rotor) and the tool (grinding wheel) in the direction of the feed axis v.

This means that up to five machine axes can be moved simultaneously to grind the surface 7 with the grinding wheel 5.

It is essential that there is always only point contact between the surface 7 and the abrasive surface of the grinding wheel 5, as indicated in FIG. 3. Point contact means that the contact area between the workpiece and the tool has only a small surface area (in contrast to this, when grinding with a profile grinding wheel, there is linear contact).

FIG. 4 shows this situation again in perspective. The groove-shaped recesses 3 of the rotor 1 (male) are machined by the grinding wheel 5. FIG. 5 shows the same situation for rotor 2 (female).

FIG. 6 shows the machining of the surface 7 of the groove-shaped recess 3, 4 in the radial stroke (in profile height direction). It is indicated how the individual machining strokes are performed by moving the grinding wheel 5 in the radial direction r, with the rotor 1, 2 correspondingly rotating about its axis of rotation a at the same time, in order to machine the surface 7 with the abrasive surface of the grinding wheel. After execution of such a machining stroke, the grinding wheel is moved further in axial direction a at the reversal points of the meandering path sketched in FIG. 6.

FIG. 7 shows the machining of the surface 7 in the axial stroke (in the direction of the profile width). It can be seen here how the grinding wheel is moved in the axial direction a of the rotor, whereby of course, according to the geometry of the profiling to be produced, the rotor 1, 2 is rotated about its axis of rotation a correspondingly. After execution of such machining stroke, at the reversal points of the meandering path sketched in FIG. 7, the grinding wheel is further moved in radial direction r. With regard to the axial stroke, it should be noted that the groove-shaped recess 3, 4 can also be ground to full depth.

It should be mentioned that a combination of the solutions according to FIGS. 6 and 7 can also be useful. In this case, there is then a combined radial and axial stroke, so that the feed direction is at an angle to the axis of rotation of the rotor.

Furthermore, it should be noted that FIGS. 6 and 7 show only the machining of the flanks of the groove-shaped recess due to their schematic representation. Of course, the process can also be used to grind the head and/or foot area of the profile of the rotor or the workpiece with a helical profile.

### LIST OF REFERENCES

1 Rotor of a screw compressor (male)
2 Rotor of a screw compressor (female)
3 Groove-shaped recess
4 Groove-shaped recess
5 Grinding tool (grinding wheel)
6 Gothic profile
7 Surface of the groove-shaped recess
P Contact point between grinding tool and surface of the profile to be machined
r Radial infeed direction
a Axial direction of the rotor (axis of rotation of the rotor)
b Axial direction of the grinding wheel
v Axis of infeed in the direction of the axis of rotation of the rotor
B Swivel axis of the grinding wheel
t Axis of infeed of the grinding wheel in axial direction of the grinding wheel

1-12. (canceled)

13. A method for producing a rotor of a screw compressor or a workpiece with a helical profile, wherein the rotor or the workpiece with a helical profile has a number of profiles in the form of groove-shaped recesses running in a spiral manner on its outer circumference, wherein the groove-shaped recesses are fine-machined using a grinding tool for the purpose of generating a precise profile, wherein the groove-shaped recesses are fine-machined with a grinding tool which only touches the surface of the groove-shaped recess at one point during the grinding process, wherein the entire surface to be machined is machined by the grinding tool through line-by-line traversing of the surface to be machined, wherein the groove-shaped recesses of the rotor or of the workpiece with a helical profile have a variable pitch or a variable profile over the axial course of the rotor or of the workpiece with a helical profile, wherein a grinding tool in the form of a grinding wheel is used, wherein the abrasive section of the grinding wheel has a gothic profile in radial section.

14. The method according to claim 13, wherein the line-by-line traversing is performed by carrying out a number of grinding strokes in which the grinding tool is moved in radial direction relative to the rotor or to the workpiece having a helical profile.

15. The method according to claim 13, wherein the line-by-line traversing is performed by carrying out a number of grinding strokes in which the grinding tool is moved in axial direction relative to the rotor or to the workpiece having a helical profile.

16. The method according to claim 13, wherein the line-by-line traversing is performed by carrying out a number of grinding strokes in which the grinding tool is moved in combination in radial direction and in axial direction relative to the rotor or to the workpiece with a helical profile.

17. The method according to claim 13, wherein as grinding wheel a steel base body tool is used which is coated with an abrasive material bonded to the steel base body by means of galvanic coating.

18. The method according to claim 13, wherein during grinding of the groove-shaped recesses the axis of rotation of the rotor or of the workpiece with a helical profile and the radial infeed movement of the grinding wheel are changed relative to another in an interpolating manner.

19. The method according to claim 13, wherein during grinding of the groove-shaped recesses the axis of rotation of the rotor or of the workpiece with a helical profile and the feed axis in the direction of the axis of rotation of the rotor or of the workpiece with a helical profile relative are changed relative to another in an interpolating manner.

20. The method according to claim 18, wherein during grinding of the groove-shaped recesses furthermore the swivel axis of the grinding tool and/or the feed axis of the grinding wheel in axial direction of the grinding wheel are interpolatingly changed.
